(19) United States
(12) Patent Application Publication
(10) Pub. No.: US 2024/0062205 A1
(43) Pub. Date: Feb. 22, 2024

(54) DEVICE, SYSTEM AND METHOD FOR MANAGING CRYPTOCURRENCY TRANSACTIONS

(71) Applicant: CHECKSIG S.R.L., Milano (IT)

(72) Inventors: Ferdinando Maria AMETRANO, Milano (IT); Paolo MAZZOCCHI, Milano (IT)

(21) Appl. No.: 18/266,408

(22) PCT Filed: Dec. 13, 2021
(86) PCT No.: PCT/IB21/61611

§ 371 Date: Jun. 9, 2023

(30) Foreign Application Priority Data
Dec. 11, 2020 (IT) 102020000030548

(51) Int. Cl. G06Q 20/40; G06Q 20/06; G06Q 20/38

(52) U.S. Cl. CPC G06Q 20/401; G06Q 20/065; G06Q 20/3829; G06Q 20/3825; G06Q 2220/00

(57) ABSTRACT

A device for managing cryptocurrency transactions has a data processing unit for receiving an authorized unsigned cryptocurrency transaction, authorized with at least M1 digital signatures generated using M1 authorization private keys from a set of N1 authorization private keys, the authorization private key being associated to a relative authorization public key, and a secure module having a secure data processing module and a secure data storage module storing a deterministic list of private keys and a fixed list of authorization public keys. The secure data processing module checks verification of the at least M1 digital signature. If verification does not succeed using all combinations of M1 different keys, the secure data processing module causes a failure of the authorized unsigned cryptocurrency transaction. If verification succeeds, the secure data processing module signs via a relative digital signature the authorized unsigned cryptocurrency transaction using a private key of the deterministic list of private keys, generating an authorized signed cryptocurrency transaction.

### FIELD OF THE INVENTION

The present invention relates to cryptocurrency technology and, namely, a device, a system and a method for managing cryptocurrency transactions.

### BACKGROUND OF THE INVENTION

As known, the bitcoin technology, as an example of cryptocurrency technology, defines a peer-to-peer electronic cash system, using a digital asset called bitcoin, operated with no central authority or banks.

The settlement of bitcoin transactions and the issuance of bitcoins are carried out collectively by a network.

A bitcoin transaction is a transfer of digital assets (bitcoins) associated to bitcoin addresses, which is registered on a blockchain, i.e. chronologically ordered and timestamped record of every transaction ever processed, shared between all the bitcoin users.

Each transaction is constructed out of several parts which enable both simple direct payments and complex transactions.

Bitcoin users rely on the so-called bitcoin wallets to keep a secret piece of data called a private key or seed or secret, which is used to sign transactions, then providing a mathematical proof that they have come from the owner of the wallet.

Thus, a signature is a mathematical mechanism that allows the transfer of bitcoins controlled by a wallet private key(s).

The signature also prevents the transaction from being altered by anybody once it has been issued.

All transactions are broadcast to the network and are confirmed through a process called mining.

Anyone can mine, i.e. process transactions using the computing power of specialized hardware and earn a reward in bitcoins for this service.

A Bitcoin transaction cannot be reversed.

Indeed, it can only be refunded by the person receiving the funds with another transaction.

When a transaction is validated, it gets included into a “block”, along with a bunch of other transactions.

Each block includes, as part of its data, a “hash value” of the previous block.

Any change in the input of the hash function changes the output and this means that a tampered change in a transaction would make the current block's hash value to change, requiring updates of all subsequent blocks, which is a very computer intensive activity.

This aspect makes the bitcoin transaction ledger virtually tamper-proof, but, at the same time, the irreversibility of a transaction requires protection against improper access to its private key.

In this regard, the bitcoin network is sharing a public ledger, i.e. a “blockchain”.

This system is used to protect against double spending and modification of previous transaction records.

The authenticity of each transaction is protected by digital signatures allowing whoever controls a private key to have full control over sending the associated bitcoins from their own Bitcoin addresses to other addresses.

This allows a Bitcoin wallet to calculate its spendable balance as bitcoin associated to addresses controlled by the Bitcoin wallet itself.

It should be noted that the integrity and the chronological ordering of the blockchain are enforced with cryptography.

In this regard, it should be observed that the bitcoin technology is a cryptographically secured digital asset technology which uses advanced asymmetric cryptography tools to improve the care, maintenance, control, and protection of bitcoin transactions.

In more detail, public key cryptography is used, which is based on a secure creation of a private key, that must be kept secret.

From the private key it is possible to generate the corresponding public key. The private key is used to unlock funds, the knowledge of this key is enough to spend the associated bitcoins.

Therefore, even though the Bitcoin technology has a strong security track record, secure key management is crucial to bitcoin safe custody.

In this regard, it should be noted that the storage of bitcoin is quite technical and, therefore, it is not suitable for everyone.

Most common vulnerabilities of the bitcoin technology are due to user's errors.

Firstly, the network provides users with protection against most prevalent types of fraud like chargebacks or unwanted charges.

Moreover, bitcoins are impossible to counterfeit.

However, it is crucial to carefully safeguard the private keys. This means that keeping bitcoins secure is mainly a matter of securing the so-called bitcoin wallets and using secure environments for signing transactions to avoid security breaches.

In this regard, there are different kinds of bitcoin wallets: the so-called software program wallet, the so-called hardware wallet which is software run in a Hardware Secure Module (HSM, the most secure approach), and the so-called paper wallet which is just storing the private key on paper.

However:
a software program wallet, generating public keys to be used for receiving bitcoins and using the corresponding private keys for spending those bitcoins, can be hacked as every software program;
a paper wallet, can be accidentally deleted, lost or stolen.

In addition, it should be noted that, among the different levels of security, the choice of the wallet solution to be used depends on the bitcoin strategy to be implemented, and the willingness to get more “technical” or not. Whatever wallet solution is chosen, unless a reliable backup or a clone of the private keys have been created, losing the access to the wallet implies losing the bitcoins.

Secondly, a bitcoin transaction is irreversible.

Therefore, if an attacker or a hacker is able to send bitcoins to a bitcoin address under his/her control, there are no technical means to revert the malicious transaction stealing the bitcoins.

Thirdly, it should be observed that, while the spendability of bitcoins, i.e. the spendability of UTxO (Unspent Transaction Output), is constrained by the bitcoin protocol and usually requires the private key the bitcoins are associated to, no further constraints are imposed on the receiver of the bitcoins.

This means that whoever accesses the private key may be able to “steal” the bitcoins, i.e. send the bitcoins to a bitcoin address under his control.

### SUMMARY OF THE INVENTION

It is the object of the present invention to devise and provide a device for managing cryptocurrency transactions which allows to solve, at least partially, the drawbacks mentioned above with reference to the prior art, guaranteeing high security level reducing as much as possible the risk that cryptocurrency may be stolen by an attacker or a hacker.

Such an object is achieved by a device according to claim 1.

Preferred embodiments of said device are defined in the dependent claims.

In addition, objects of the present invention are a system for managing cryptocurrency transactions using said device and a method for managing cryptocurrency transactions.

### BRIEF DESCRIPTION OF THE FIGURES

Further features and advantages of the device, the system and method according to the present invention will become apparent in the following description which shows preferred embodiments, given by way of indicative, non-limiting examples, with reference to the accompanying drawings, in which:

FIG. 1 schematically shows, by a block diagram, a device for managing cryptocurrency transaction according to the present invention;

FIG. 2 schematically shows, by means of a block scheme, a system for managing cryptocurrency transaction using the device of FIG. 1, according to an embodiment of the present invention;

FIG. 3 schematically shows, by means of a block scheme, an operation of the device of FIG. 1, according to an embodiment of the present invention;

FIG. 4 schematically shows, by means of a block scheme, an operation of the device of FIG. 1, according to a further embodiment of the present invention, and

FIG. 5 schematically shows, by means of a block diagram, a method for managing cryptocurrency transaction according to an embodiment of the present invention.

### DETAILED DESCRIPTION

With reference to the aforesaid figures, according to the present invention, it will now be described a device 100 for managing cryptocurrency transactions, in the following also simply device 100.

Examples of cryptocurrency are bitcoin, ether, litecoin, etc.

The device 100 comprises a data processing unit 101, e.g. a microcontroller or microprocessor.

The device 100 further comprises a data storage unit 102 operatively connected to the data processing unit 101.

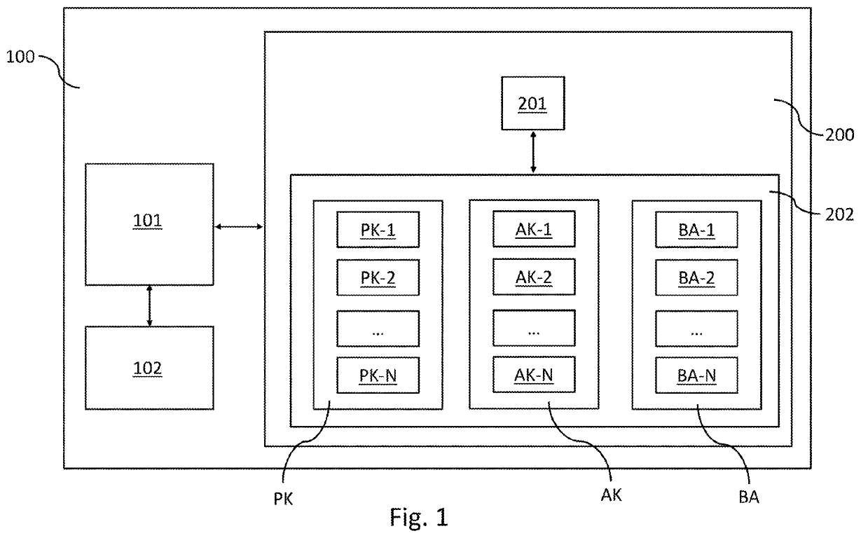

The data storage unit 102 may be internal or external (such as shown in FIG. 1, for example) with respect to the data processing unit 101.

It is worth noting that the data storage unit 102 is configured to store one or more program codes which can be executed by the data processing unit 101 and the data generated and processed upon the execution of said one or more program codes.

In this regard, the data processing unit 101 of the device 100 is configured to manage cryptocurrency transactions.

In particular, the data processing unit 101 of the device 100 is configured to receive an authorized unsigned cryptocurrency transaction AU-BT.

As it will be explained in the following, an authorized unsigned cryptocurrency transaction AU-BT is received from a third-party authority 300 (defined below), schematically shown in FIG. 1.

The authorized unsigned cryptocurrency transaction AU-BT received by the data processing unit 101 of the device 100 has been authorized with at least M1 digital signatures AD-1 generated using M1 authorization private keys APK-1 from a set of N1 authorization private keys, wherein 0<M1≤N1 and M1, N1 are integers.

N1 represents the number of entities entrusted with the authorization process.

In the figures, the authorized digital signature has been indicated with AD-1.

Examples of the digital signature scheme used to authorize the transaction are ECDSA (Elliptic Curve Digital Signature Algorithm), Schnorr signature algorithm.

It should be noted that the authorization private key APK-1 is associated to a relative authorization public key AK-1.

The device 100 further comprises a secure module 200, operatively connected to the data processing unit 101.

For the purposes of the present invention, “secure” module means a hardware security module (HSM), i.e. a physical computing device that safeguards and manages digital keys, performs encryption and decryption functions for digital signatures, strong authentication and other cryptographic functions. The same applies on “secure” data processing module and “secure” data storage module, defined below.

The secure module 200 comprises a secure data processing module 201, e.g. a microcontroller or microprocessor.

The secure module 200 further comprises a secure data storage module 202 operatively connected to the secure data processing module 201.

The secure data storage module 202 may be internal or external (such as shown in FIG. 1, for example) with respect to the secure data processing module 201.

The secure data storage module 202 is configured to store a deterministic list of private keys PK used to sign cryptocurrency transaction via digital signature.

The deterministic list of private keys PK is derived from a common secret.

The secure data storage module 202 is further configured to store a fixed list of N1 authorization public keys AK.

It is worth noting that the secure data storage module 202 is configured to store one or more program codes which can be executed by the storage data processing module 201 and the data generated and processed upon the execution of said one or more program codes.

In this regard, the storage data processing module 201 of the secure module 200 of the device 100 is configured to manage cryptocurrency transactions.

In particular, the secure data processing module 201 of the secure module 200 is configured to check, using an algorithm of digital signature validity verification (for example, ECDSA or Schnorr verification schema), if the verification of the at least M1 digital signatures AD-1 used to authorize said authorized unsigned cryptocurrency transaction AU-BT succeeds using M1 different keys in the fixed list of N1 authorization public keys AK stored in the secure data storage module 202 of the secure module 200 of the device 100.

In this regard, the secure data processing module 201 of the secure module 200 is configured, in the case the verification of the at least M1 digital signatures AD-1 used to authorize said authorized unsigned cryptocurrency transaction AU-BT, does not succeed using all combination of M1 different keys in the fixed list of N1 authorization public keys AK stored in the secure data storage module 202 of the secure module 200 of the device 100, to cause a failure FL of the cryptocurrency transaction AU-BT.

Furthermore, the secure data processing module 201 of the secure module 200 is configured, in the case the verification of at least M1 digital signatures AD-1 used to authorize said authorized unsigned cryptocurrency transaction AU-BT, succeeds using M1 different keys in the fixed list of N1 authorization public keys AK stored in the secure data storage module 202 of the secure module 200 of the device 100, to sign via a relative digital signature AD-2 the authorized unsigned cryptocurrency transaction AU-BT using a private key PK-1 of said deterministic list of private keys PK, generating an authorized signed cryptocurrency transaction AS-BT.

It should be noted that a minimum number of M2 devices 100 (0<M2≤N2, wherein M2 and N2 are integers) are needed to sign the authorized unsigned cryptocurrency transaction AU-BT to consider the authorized unsigned cryptocurrency transaction AU-BT as validly signed.

N2 is an integer which represents the number of devices 100 which can be employed in the overall process (0<M2≤N2).

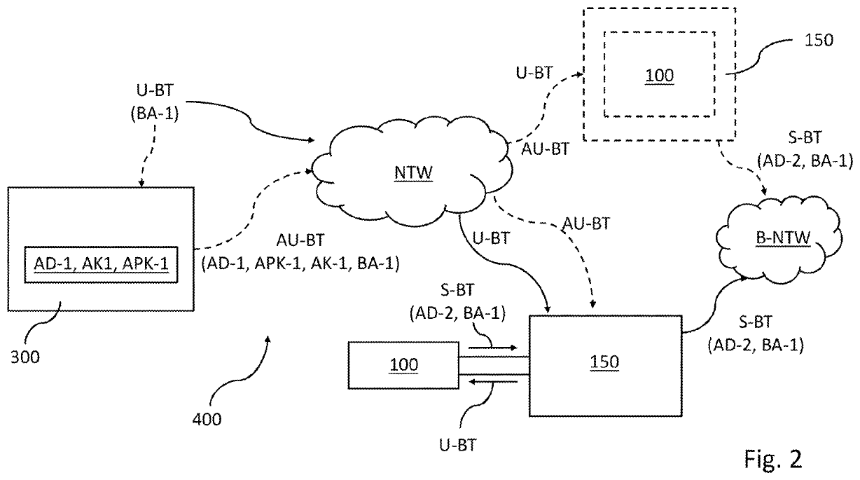

With reference to FIG. 2, according to an embodiment, in combination with the one previously described, the device 100 is further configured to be operatively connected to an electronic calculator 150 of a user.

Examples of an electronic calculator 150 of the user are a personal computer, a laptop, a tablet, a smartphone and so on.

The electronic calculator 150 is configured to be used by the user to send the received authorized unsigned cryptocurrency transaction AU-BT to the device 100.

According to an embodiment, in combination with the previous one, the data processing unit 101 of the device 100 is further configured to send to the electronic calculator 150 of the user the authorized signed cryptocurrency transaction AS-BT.

With reference again to FIG. 2, the electronic calculator 150 of the user is further configured to broadcast the authorized signed cryptocurrency transaction AS-BT received from the device 100 to a cryptocurrency communication network B-NTW (schematically shown in FIG. 2).

Examples of cryptocurrency communication network B-NTW can be the bitcoin network, the Ethereum network, the litecoin network, etc.

According to a further embodiment, in combination with any of the previous ones describing the electronic calculator 150 of the user and schematically shown in FIG. 2, the device 100 is a portable device which is distinct from and external to the electronic calculator 500 and it is configured to be operatively connected to the electronic calculator 150 of the user, e.g. via a USB connection or a wireless connection (e.g. Bluetooth, Wi-fi, etc).

According to an embodiment, alternative to the previous one and schematically shown with dotted lines in FIG. 2, the device 100 is embedded within the electronic calculator 150 of the user.

According to an embodiment, in combination with any of the previous ones, the authorized unsigned cryptocurrency transaction AU-BT has associated a relative destination cryptocurrency address BA-1.

In this embodiment, the secure data storage module 202 of the secure module 200 of the device 100 is further configured to store a list of destination cryptocurrency addresses BA (FIG. 1).

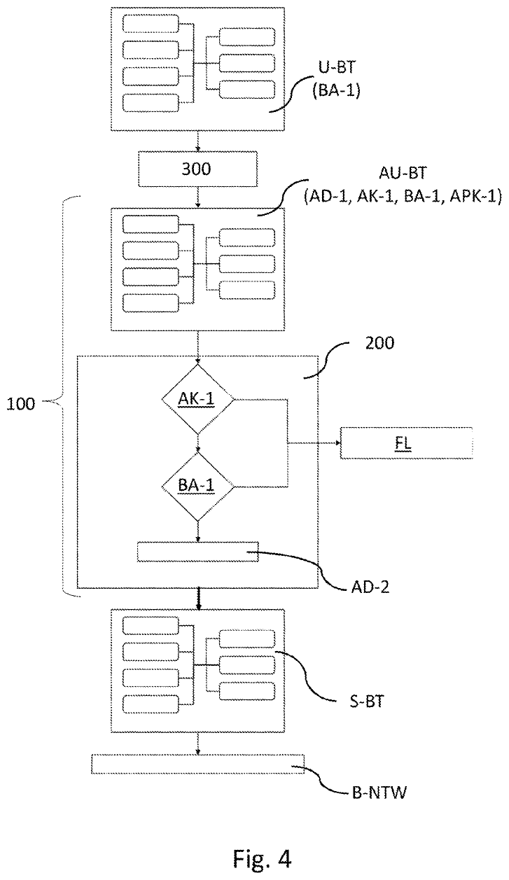

In this embodiment, shown in particular in FIG. 4, the secure data processing module 201 of the secure module 200 of the device 100 is further configured to check, after having checked if the verification of the at least M1 digital signatures AD-1 used to authorize the authorized unsigned cryptocurrency transaction AU-BT succeeds using M1 different keys in the fixed list of N1 authorization public keys AK stored in the secure data storage module 202 of the secure module 200 of the device 100, if the relative destination cryptocurrency address BA-1 associated to the authorized unsigned cryptocurrency transaction AU-BT belongs to the list of destination cryptocurrency addresses BA stored in the secure data storage module 202 of the secure module 200 of the device 100.

The secure data processing module 201 of the secure module 200 of the device 100 is configured, in the case the destination cryptocurrency address BA-1 associated to the authorized unsigned cryptocurrency transaction AU-BT does not belong to the list of destination cryptocurrency addresses BA stored in the secure data storage module 202 of the secure module 200 of the device 100, to cause a failure FL of the cryptocurrency transaction AU-BT.

Furthermore, the secure data processing module 201 of the secure module 200 of the device 100 is configured to sign via the relative digital signature AD-2 the authorized unsigned cryptocurrency transaction AU-BT using a private key PK-1 of said deterministic list of private keys PK, generating the authorized signed cryptocurrency transaction AS-BT, in the case the destination address BA-1 associated to the authorized unsigned cryptocurrency transaction AU-BT belongs to the list of destination cryptocurrency addresses BA stored in the secure data storage module 202 of the secure module 200 of the device 100.

According to an example, it should be noted that generating the authorized signed cryptocurrency transaction AS-BT can be performed also in a multi-sign context, i.e. using a plurality of devices 100.

According with a further embodiment, in combination with any of the ones previously described, the data processing unit 101 is configured to receive the authorized unsigned cryptocurrency transaction AU-BT from a third-party authority 300, schematically shown in FIG. 1.

Examples of third-party authority 300 are custodian, escrow, notary services, etc.

The third-party authority 300 is configured to receive an unsigned cryptocurrency transaction U-BT.

The unsigned cryptocurrency transaction U-BT can be received from an entity different from the third-party authority entrusted with the authorization process, e.g. back-office operators of custodian, escrow, notary services, agents etc.

The unsigned cryptocurrency transaction U-BT has associated a destination cryptocurrency address BA-1.

As an example, the third-party authority 300 comprises N1 different agents and is configured to authorize said unsigned cryptocurrency transaction U-BT using digital signatures.

In more detail, to be authorized, the unsigned cryptocurrency transaction U-BT needs to be digitally signed with at least M1 digital signatures AD-1 generated using the relative M1 authorization private keys APK-1 from a set of N1 authorization private keys, where 0<M1≤N1 and M1, N1 are integers.

With reference to FIG. 2, a system 400 for managing cryptocurrency transactions, in the following also simply system 400, comprises the device 100 previously described according to several embodiments.

The system 400 further comprises an electronic calculator 150 of a user, previously described.

The device 100 is configured to be operatively connected to said electronic calculator 150.

As previously described, the electronic calculator 150 is configured to be used by the user to:
send the authorized unsigned cryptocurrency transaction AU-BT to the device 100;
broadcast the authorized signed cryptocurrency transaction AS-BT received from the device 100 to a cryptocurrency communication network B-NTW.

Once the authorized signed cryptocurrency transaction AS-BT is published on the cryptocurrency communication network B-NTW and confirmed, the correspondent amount will be available to the recipient.

According to an embodiment, in combination with the previous one and shown in FIG. 2, the system 400 further comprises at least one third party authority 300 operatively connected to the electronic calculator 150 of the user via a data communication network NTW, e.g. Internet, in order to authorize the unsigned cryptocurrency transaction U-BT and send the authorized unsigned cryptocurrency transaction AU-BT to the electronic calculator 150 of the user.

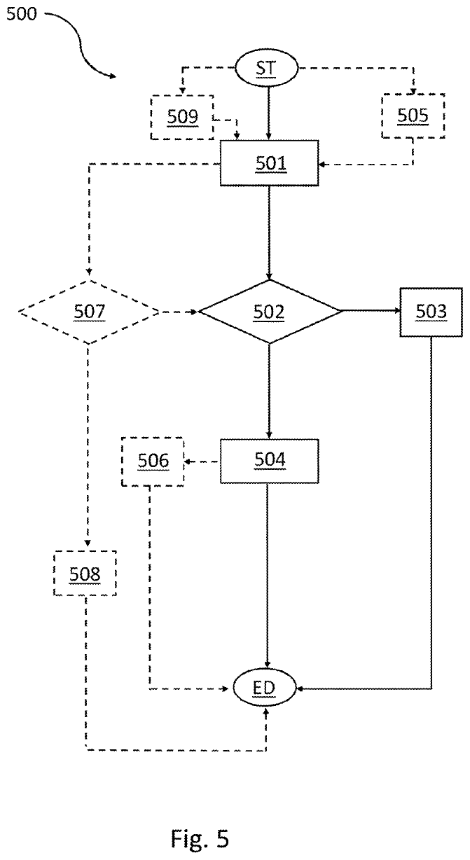

With reference to FIG. 5, a method 500 for managing cryptocurrency transactions, in the following also simply method 500, is now described.

The method 500 comprises a symbolic step of starting ST.

The method 500 comprises a step of receiving 501, by a data processing unit 101 of a device 100 for managing cryptocurrency transactions, an authorized unsigned cryptocurrency transaction AU-BT.

The device 100 has been previously described with reference to several embodiments.

The authorized unsigned cryptocurrency transaction AU-BT has been authorized with at least M1 digital signatures AD-1 generated using M1 authorization private keys APK-1 from a set of N1 authorization private keys, wherein 0<M1≤N1 and M1, N1 are integers.

N1 represents the number of entities entrusted with the authorization process.

In the figures, the authorized digital signature has been indicated with AD-1.

Examples of the digital signature scheme used to authorize the transaction have been previously provided.

The authorization private key APK-1 is associated to a relative authorization public key AK-1.

The method 500 further comprises a step of checking 502, by a secure data processing module 201 of a secure module 200 of the device 100, using an algorithm of digital signature validity verification (examples have been previously provided), if the verification of the at least M1 digital signatures AD-1 used to authorize said authorized unsigned cryptocurrency transaction AU-BT succeeds using M1 different keys in a fixed list of N1 authorization public keys AK stored in the secure data storage module 202 of the secure module 200 of the device 100.

The method 500 comprises a step of causing 503, in the case the verification of the at least M1 digital signatures AD-1 used to authorize said authorized unsigned cryptocurrency transaction AU-BT, does not succeed using all combination of M1 different keys in the fixed list of N1 authorization public keys AK stored in the secure data storage module 202 of the secure module 200 of the device 100, a failure FL of the cryptocurrency transaction AU-BT.

The method 500 further comprises, in the case the verification of the at least M1 digital signatures AD-1 used to authorize said authorized unsigned cryptocurrency transaction AU-BT, succeeds using M1 different keys in the fixed list of N1 authorization public keys AK stored in the secure data storage module 202 of the secure module 200 of the device 100, a step of signing 504, via a relative digital signature AD-2, the authorized unsigned cryptocurrency transaction AU-BT using a private key PK-1 of said deterministic list of private keys PK, generating an authorized signed cryptocurrency transaction AS-BT.

It should be noted that a minimum number of M2 devices 100 (0<M2≤N2, wherein M2 and N2 are integers) are needed to sign the authorized unsigned cryptocurrency transaction AU-BT in order to considered the authorized unsigned cryptocurrency transaction AU-BT as validly signed.

N2 is an integer which represents the number of devices 100 which can be employed in the overall process (0<M2≤N2).

The method 500 comprises a symbolic step of ending ED.

According to an embodiment, in combination with the previous one and shown with dotted lines in FIG. 5, the method 500 further comprises a step of sending 505, by an electronic calculator 150 of a user, the received authorized unsigned cryptocurrency transaction AU-BT to the device 100.

The electronic calculator 150 of the user has been previously described.

According to an embodiment, in combination with any of the ones previously described, the method 500 further comprises a step of sending 506, by the data processing unit 101 of the device 100, the authorized signed cryptocurrency transaction AS-BT to the electronic calculator 150 of the user.

According to an embodiment, in combination with any of the ones previously described, the authorized unsigned cryptocurrency transaction AU-BT has associated a relative destination cryptocurrency address BA-1.

In this embodiment, the method 500 further comprises a step of checking 507, by the secure data processing module 201 of the secure module 200 of the device 100, after having checked 502 if the verification of the at least M1 digital signatures AD-1 used to authorize the authorized unsigned cryptocurrency transaction AU-BT succeeds using M1 different keys in the fixed list of N1 authorization public keys AK stored in the secure data storage module 202 of the secure module 200 of the device 100, if the relative destination cryptocurrency address BA-1 associated to the authorized unsigned cryptocurrency transaction AU-BT belongs to a list of destination cryptocurrency addresses BA stored in the secure data storage module 202 of the secure module 200 of the device 100.

In this embodiment, the method 500 comprises, in the case the destination address BA-1 associated to the authorized unsigned cryptocurrency transaction AU-BT does not belong to the list of destination cryptocurrency addresses BA stored in the secure data storage module 202 of the secure module 200 of the device 100, a step of causing 508, by the secure data processing module 201 of the secure module 200 of the device 100, a failure FL of the cryptocurrency transaction.

In this embodiment, the step of signing 504, via a relative digital signature AD-2, the authorized unsigned cryptocurrency transaction AU-BT using a private key PK-1 of said deterministic list of private keys PK, generating an authorized signed cryptocurrency transaction AS-BT, is performed, by the secure data processing module 201 of the secure module 200 of the device 100, in the case the destination cryptocurrency address BA-1 associated to the authorized unsigned cryptocurrency transaction AU-BT belongs to the list of destination cryptocurrency addresses BA stored in the secure data storage module 202 of the secure module 200 of the device 100.

According to an example, it should be noted that generating the authorized signed cryptocurrency transaction AS-BT can be performed also in a multi-sign context, i.e. using a plurality of devices 100.

According to an embodiment, in combination with the previous one, the method 500 further comprises a step of receiving 509, by the data processing unit 101 of the device 100, the authorized unsigned cryptocurrency transaction AU-BT from a third-party authority 300.

The third-party authority 300 has been previously described.

The authorized unsigned cryptocurrency transaction AU-BT has been authorized by the third-party authority 300 starting from an unsigned cryptocurrency transaction U-BT received by the third-party authority, using the digital signature AD-1 generated using the relative authorization private key APK-1.

The unsigned cryptocurrency transaction U-BT can be received from an entity different from the third-party authority entrusted with the authorization process, e.g. back-office operators of custodian, escrow, notary services, agents etc.

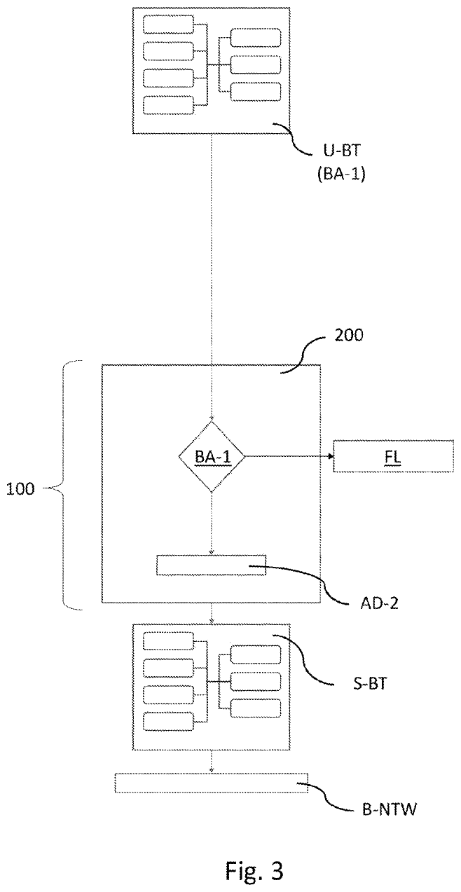

With reference to FIGS. 1, 2 and 3, an operation of the device 100 and system 400 for managing cryptocurrency transactions is now described, according to an embodiment of the present invention.

A third-party authority 300 receives an unsigned cryptocurrency transaction U-BT and authorize the relative authorized unsigned cryptocurrency transaction AU-BT using a digital signature AD-1 generated using the relative authorization private key APK-1.

The authorization private key APK-1 is associated to a relative authorization public key AK-1.

The device 100, a portable device operatively connected to an electronic calculator 150 (e.g. a laptop) of the user, e.g. via a USB connection, receives the authorized unsigned cryptocurrency transaction AU-BT.

A secure data processing module 201 of a secure module 200 of the device 100 checks, using an algorithm of digital signature validity verification, if the verification of the at least M1 digital signatures AD-1 used to authorize the authorized unsigned cryptocurrency transaction AU-BT succeeds using M1 different keys in the fixed list of N1 authorization public keys AK stored in the secure data storage module 202 of the secure module 200 of the device 100.

The secure data processing module 201 of the secure module 200, in the case the verification of the at least M1 digital signatures AD-1 used to authorize the authorized unsigned cryptocurrency transaction AU-BT succeeds using M1 different keys in the fixed list of N1 authorization public keys AK stored in the secure data storage module 202 of the secure module 200 of the device 100, then signs via a relative digital signature AD-2 the authorized unsigned cryptocurrency transaction AU-BT using a private key PK-1 of said deterministic list of private keys PK, generating an authorized signed cryptocurrency transaction AS-BT.

The data processing unit 101 of the device 100 sends to the electronic calculator 150 of the user the authorized signed cryptocurrency transaction AS-BT.

The electronic calculator 150 of the user broadcasts the authorized signed cryptocurrency transaction AS-BT received from the device 100 to a cryptocurrency communication network B-NTW.

Once the authorized signed cryptocurrency transaction AS-BT is published on the cryptocurrency communication network B-NTW and confirmed, the correspondent amount will be available to the recipient.

As may be seen, the object of the invention is fully achieved.

Indeed, the device, the system and the method according to the present invention increase the security both in the build of a trusted environment in the set-up process, and in the use of the hardware secure module of the device itself.

The configuration according to the invention allows to reduce the risk of losing cryptocurrencies (e.g. bitcoins) to an attacker that gets hold of the hardware security module.

Indeed, the attacker cannot move funds without the required authorization to be obtained generating a digital signature using an authorization private key which relative public key belongs to the fixed list of authorization public keys stored in the secure storage unit of the secure module of the device.

In addition, according to a further embodiment, said risk of losing cryptocurrencies to an attacker that gets hold of the hardware security module is further decreased, because the attacker cannot send the funds to a destination cryptocurrency address under his/her control.

Instead, the attacker could only move the funds to a list of destination cryptocurrency addresses stored in a secure storage unit of the secure module of the device 100, i.e. only to addresses previously whitelisted.

The above risk mitigations effectively dissuade an attacker from attempting an attack that cannot be technically accomplished.

Consequently, threats to the hardware secure module owner are significantly reduced.

Those skilled in the art may make changes and adaptations to the above-described embodiments of the device, the system and the method for managing cryptocurrency transactions or can replace elements with others which are functionally equivalent in order to meet contingent needs without departing from the scope of the following claims. Each of the features described as belonging to one possible embodiment may be implemented independently of the other embodiments described.

What is claimed is:

1. A device for managing cryptocurrency transactions, comprising:
a data processing unit configured to receive an authorized unsigned cryptocurrency transaction, wherein said authorized unsigned cryptocurrency transaction has been authorized with at least M1 digital signatures generated using M1 authorization private keys from a set of N1 authorization private keys, wherein 0<M1≤N1 and M1, N1 are integers, said authorization private key being associated to a relative authorization public key;
a secure module, operatively connected to the data processing unit, comprising:
a secure data processing module;
a secure data storage module operatively connected to the secure data processing module, said secure data storage module being configured to store:
a deterministic list of private keys used to sign the cryptocurrency transactions via digital signature, said deterministic list of private keys being derived from a common secret;
a fixed list of N1 authorization public keys,
said secure data processing module of the secure module being configured to:
check, using an algorithm of digital signature validity verification, if verification of the at least M1 digital signature used to authorize the authorized unsigned cryptocurrency transaction succeeds using M1 different keys in the fixed list of N1 authorization public keys stored in the secure data storage module of the secure module of the device,
in the case the verification of the at least M1 digital signature used to authorize the authorized unsigned cryptocurrency transaction does not succeed using all combinations of M1 different keys in the fixed list of N1 authorization public keys stored in the secure data storage module of the secure module of the device, cause a failure of the authorized unsigned cryptocurrency transaction;
in the case the verification of the at least M1 digital signature used to authorize the authorized unsigned cryptocurrency transaction succeeds using M1 different keys in the fixed list of N1 authorization public keys stored in the secure data storage module of the secure module of the device, sign via a relative digital signature the authorized unsigned cryptocurrency transaction using a private key of said deterministic list of private keys, generating an authorized signed cryptocurrency transaction.

2. The device of claim 1, wherein the device is configured to be operatively connected to an electronic calculator of a user, said electronic calculator being configured to be used by the user to send the received authorized unsigned cryptocurrency transaction to the device.

3. The device of claim 2, wherein the data processing unit of the device is further configured to send to the electronic calculator of the user the authorized signed cryptocurrency transaction.

4. The device of claim 2, wherein the device is a portable device distinct from and external to the electronic calculator and configured to be operatively connected to the electronic calculator.

5. The device of claim 2, wherein the device is embedded within the electronic calculator of the user.

6. The device of claim 1, wherein said authorized unsigned cryptocurrency transaction has associated a relative destination cryptocurrency address, said secure data storage module of the secure module of the device being further configured to store a list of destination cryptocurrency addresses;
said secure data processing module of the secure module of the device being further configured to check, after having checked if the verification of the at least M1 digital signature used to authorize the authorized unsigned cryptocurrency transaction succeeds using M1 different keys in the fixed list of N1 authorization public keys stored in the secure data storage module of the secure module of the device, if the relative destination cryptocurrency address associated to the authorized unsigned cryptocurrency transaction belongs to the list of destination cryptocurrency addresses stored in the secure data storage module of the secure module of the device,
said secure data processing module of the secure module of the device being configured, in the case the relative destination cryptocurrency address associated to the authorized unsigned cryptocurrency transaction does not belong to the list of destination cryptocurrency addresses stored in the secure data storage module of the secure module of the device, to cause a failure of the authorized unsigned cryptocurrency transaction,
said secure data processing module of the secure module of the device being configured to sign via the relative digital signature the authorized unsigned cryptocurrency transaction using the private key of said deterministic list of private keys, generating the authorized signed cryptocurrency transaction, in the case the relative destination address associated to the authorized unsigned cryptocurrency transaction belongs to the list of destination cryptocurrency addresses stored in the secure data storage module of the secure module of the device.

7. The device of claim 6, wherein said data processing unit is configured to receive the authorized unsigned cryptocurrency transaction from a third-party authority, said third-party authority being configured to receive an unsigned cryptocurrency transaction, said unsigned cryptocurrency transaction having associated a relative destination cryptocurrency address, said third party authority being configured to authorize said unsigned cryptocurrency transaction using the relative digital signature generated using the relative authorization private key.

8. A system comprising:
a device for managing cryptocurrency transactions, comprising:
a data processing unit configured to receive an authorized unsigned cryptocurrency transaction, wherein said authorized unsigned cryptocurrency transaction has been authorized with at least M1 digital signatures generated using M1 authorization private keys from a set of N1 authorization private keys, wherein 0<M1≤N1 and M1, N1 are integers, said authorization private key being associated to a relative authorization public key;
a secure module, operatively connected to the data processing unit, comprising:
a secure data processing module;
a secure data storage module operatively connected to the secure data processing module, said secure data storage module being configured to store:
a deterministic list of private keys used to sign the cryptocurrency transactions via digital signature, said deterministic list of private keys being derived from a common secret;
a fixed list of N1 authorization public keys,
said secure data processing module of the secure module being configured to:
check, using an algorithm of digital signature validity verification, if verification of the at least M1 digital signature used to authorize the authorized unsigned cryptocurrency transaction succeeds using M1 different keys in the fixed list of N1 authorization public keys stored in the secure data storage module of the secure module of the device,
in the case the verification of the at least M1 digital signature used to authorize the authorized unsigned cryptocurrency transaction does not succeed using all combinations of M1 different keys in the fixed list of N1 authorization public keys stored in the secure data storage module of the secure module of the device, cause a failure of the authorized unsigned cryptocurrency transaction;
in the case the verification of the at least M1 digital signature used to authorize the authorized unsigned cryptocurrency transaction succeeds using M1 different keys in the fixed list of N1 authorization public keys stored in the secure data storage module of the secure module of the device, sign via a relative digital signature the authorized unsigned cryptocurrency transaction using a private key of said deterministic list of private keys, generating an authorized signed cryptocurrency transaction,
wherein the device is configured to be operatively connected to an electronic calculator of a user, said electronic calculator being configured to be used by the user to send the received authorized unsigned cryptocurrency transaction to the device, and wherein the device is a portable device distinct from and external to the electronic calculator and configured to be operatively connected to the electronic calculator;
an electronic calculator of a user, said device being configured to be operatively connected to said electronic calculator, said electronic calculator being configured to be used by the user to:
send the authorized unsigned cryptocurrency transaction to the device;
broadcast the authorized signed cryptocurrency transaction received from the device to a cryptocurrency communication network.

9. The system of claim 8, further comprising at least one third-party authority operatively connected to the electronic calculator of the user via a data communication network to send the authorized unsigned cryptocurrency transaction to the electronic calculator of the user.

10. A method for managing cryptocurrency transactions, the method comprising:
receiving, by a data processing unit of a device for managing cryptocurrency transactions, an authorized unsigned cryptocurrency transaction, wherein said authorized unsigned cryptocurrency transaction has been authorized with at least M1 digital signatures generated using M1 authorization private keys from a set of N1 authorization private keys, wherein 0<M1≤N1 and M1, N1 are integers, said authorization private key being associated to a relative authorization public key;
checking, by a secure data processing module of a secure module of the device, using an algorithm of digital signature validity verification, if verification of the at least M1 digital signatures used to authorize said authorized unsigned cryptocurrency transaction succeeds using M1 different keys in a fixed list of N1 authorization public keys stored in the secure data storage module of the secure module of the device;
in the case the verification of the at least M1 digital signatures used to authorize said authorized unsigned cryptocurrency transaction does not succeed using all combinations of M1 different keys in the fixed list of N1 authorization public keys stored in the secure data storage module of the secure module of the device, causing a failure of the authorized unsigned cryptocurrency transaction;
in the case the verification of the at least M1 digital signatures used to authorize said authorized unsigned cryptocurrency transaction succeeds using M1 different keys in the fixed list of N1 authorization public key stored in the secure data storage module of the secure module of the device, signing, by the secure data processing module of the secure module of the device, via a relative digital signature, the authorized unsigned cryptocurrency transaction using a private key of a deterministic list of private keys, generating an authorized signed cryptocurrency transaction.

11. The method of claim 10, further comprising sending, by an electronic calculator of a user, the received authorized unsigned cryptocurrency transaction to the device.

12. The method of claim 11, further comprising sending, by the data processing unit of the device, the authorized signed cryptocurrency transaction to the electronic calculator of the user.

13. The method of claim 10, wherein said authorized unsigned cryptocurrency transaction has associated a relative destination cryptocurrency address, the method further comprising:
checking, by the secure data processing module of the secure module of the device, after having checked if the verification of the at least M1 digital signature used to authorize the authorized unsigned cryptocurrency transaction succeeds using M1 different keys in the fixed list of N1 authorization public keys stored in the secure data storage module of the secure module of the device, if the relative destination cryptocurrency address associated to the authorized unsigned cryptocurrency transaction belongs to a list of destination cryptocurrency addresses stored in the secure data storage module of the secure module of the device;
in the case the relative destination address associated to the authorized unsigned cryptocurrency transaction does not belong to the list of destination cryptocurrency addresses stored in the secure data storage module of the secure module of the device, causing, by the secure data processing module of the secure module of the device, a failure of the authorized unsigned cryptocurrency transaction;
the step of signing via the relative digital signature, the authorized unsigned cryptocurrency transaction using the private key of said deterministic list of private keys, generating the authorized signed cryptocurrency transaction, being performed, by the secure data processing module of the secure module of the device, in the case the relative destination cryptocurrency address associated to the authorized unsigned cryptocurrency transaction belongs to the list of destination cryptocurrency addresses stored in the secure data storage module of the secure module of the device.

14. The method of claim 13, further comprising receiving, by the data processing unit of the device, the authorized unsigned cryptocurrency transaction from a third-party authority, said authorized unsigned cryptocurrency transaction having been authorized by the third party authority starting from an unsigned cryptocurrency transaction received by the third party authority, using the relative digital signature generated using the relative authorization private key.
